(19) United States
(12) Patent Application Publication
(10) Pub. No.: US 2014/0189626 A1
(43) Pub. Date: Jul. 3, 2014

(54) CIRCUIT WIDTH THINNING DEFECT PREVENTION DEVICE AND METHOD OF PREVENTING CIRCUIT WIDTH THINNING DEFECT

(71) Applicant: SAMSUNG ELECTRO-MECHANICS CO., LTD., Suwon (KR)

(72) Inventors: Jung Kyung SUNG, Busan (KR); Bong Wan Koo, Changwon (KR); Won Woo Cho, Busan (KR)

(73) Assignee: SAMSUNG ELECTRO-MECHANICS CO., LTD., Suwon (KR)

(21) Appl. No.: 14/143,706

(22) Filed: Dec. 30, 2013

(30) Foreign Application Priority Data
Dec. 31, 2012 (KR) 10-2012-0158336

(51) Int. Cl. G06F 17/50

(52) U.S. Cl. CPC G06F 17/5081
USPC 716/112

(57) ABSTRACT

The present invention relates to a circuit width thinning defect prevention device and a method of preventing a circuit width thinning defect, and can prevent a circuit width thinning defect, that is, a reduction in circuit width due to excessive etching on a specific portion by including a storage means for storing dam design information classified according to the type of a weak portion; an analysis means for analyzing first design information to deduce the type and position of the weak portion; a matching means for extracting the dam design information corresponding to the type of the weak portion from the dam design information stored in the storage means; and a change means for changing the first design information to add a dam according to the dam design information extracted by the matching means to the position of the weak portion deduced by the analysis means.

### CROSS-REFERENCE TO RELATED APPLICATIONS

Claim and incorporate by reference domestic priority application and foreign priority application as follows:

### Cross Reference to Related Application

This application claims the benefit under 35 U.S.C. Section 119 of Korean Patent Application Serial No. 10-2012-0158336, entitled filed Dec. 31, 2012, which is hereby incorporated by reference in its entirety into this application.

### BACKGROUND OF THE INVENTION

1. Field of the Invention

The present invention relates to a circuit width thinning defect prevention device and a method of preventing a circuit width thinning defect.

2. Description of the Related Art

One of the widely used methods in the field of printed circuit boards is a tenting method.

The tenting method is a method of forming a circuit pattern by forming a resist pattern on a surface of a conductive layer using a dry film etc., removing the conductive layer in the region in which the resist pattern isn't formed, that is, in the region exposed outside the resist pattern through etching, and removing the resist pattern and introduced in many documents such as Patent Document 1.

In recent times, as there are increasing demands for slimming and miniaturization as well as high performance of electronic devices, fine patterns are formed in thin and narrow areas with high integration.

Meanwhile, these circuit patterns may be designed in various shapes, and the flow rate of an etching solution may be changed according to the design of the circuit pattern. As a result, a difference in etching amount may occur.

FIG. 1 is a view for explaining the difference in etching amount according to the flow rate of an etching solution.

Referring to FIG. 1, the flow rate of the etching solution is relatively high in the portions in which the interval between the circuit patterns is wide like region A and relatively low in the portions in which the interval between the circuit patterns is narrow like region C.

Therefore, the etching amount in the region A is increased than the etching amount in the region C.

Further, in the portion in which the interval between the circuit patterns is wide and then reduced like region B, the flow rate of the etching solution is rapidly increased. Accordingly, excessive etching of the circuit patterns occurs. This phenomenon frequently occurs in the region represented by B1.

This excessive etching phenomenon causes a reduction in circuit width that is a so-called circuit width thinning defect. The circuit width thinning defect causes an increase in impedance, thus causing degradation of product performance than design values.

In the prior art, in order to prevent a circuit width thinning defect, a method of collectively increasing or decreasing the width of a circuit pattern or a pad has been applied.

However, it was impossible to prevent a circuit width thinning defect occurring in specific regions such as the region B of FIG. 1 only by the method of collectively increasing a circuit width.

FIGS. 2(a) and 2(b) are views showing weak portions in which a circuit width thinning defect occurs.

Referring to FIGS. 2(a) and 2(b), it is checked that the circuit width thinning defect occurs due to excessive etching in the portion in which the flow rate of an etching solution increases.

This circuit width thinning defect has emerged as a serious problem according to a reduction in circuit width. Thus, a means of overcoming this is urgently needed.

### RELATED ART DOCUMENT

### Patent Document

Patent Document 1: Korean Patent Laid-open Publication No. 2003-0012978

### SUMMARY OF THE INVENTION

The present invention has been invented in order to overcome the above-described problems and it is, therefore, an object of the present invention to provide a circuit width thinning defect prevention device and a method of preventing a circuit width thinning defect that can prevent a circuit width thinning defect.

In accordance with one aspect of the present invention to achieve the object, there is provided a circuit width thinning defect prevention device for preventing a circuit width thinning defect of a weak portion by using first design information and second design information which are data related to a design for forming a circuit pattern, including: a storage means for storing dam design information classified according to the type of the weak portion; an analysis means for analyzing the first design information to deduce the type of the weak portion and the position of the weak portion; a matching means for extracting the dam design information corresponding to the type of the weak portion deduced by the analysis means from the dam design information stored in the storage means; and a change means for changing the first design information to add a dam according to the dam design information extracted by the matching means to the position of the weak portion deduced by the analysis means.

At this time, the weak portion may be a first weak portion positioned on a first circuit pattern between the first circuit pattern and a second circuit pattern adjacent to the first circuit pattern.

Further, the first weak portion may be a point where the distance between the first circuit pattern and the second circuit pattern is changed.

Further, the first weak portion may be a point where the angle between a virtual line positioned on the first circuit pattern in parallel to the second circuit pattern and the first circuit pattern is changed by more than 1 degree.

Further, the dam may have a triangular shape.

Further, one side of the dam may be in contact with the first circuit pattern, one vertex of the side in contact with the first circuit pattern may be positioned in the first weak portion, and the other vertex may be positioned in the direction in which the interval between the first circuit pattern and the second circuit pattern increases.

Further, at least one of the sides of the dam, which are not in contact with the first circuit pattern, may be parallel to the second circuit pattern.

Further, the weak portion may be a second weak portion positioned on the first circuit pattern between the first circuit pattern and a pad adjacent to the first circuit pattern.

Further, the second weak portion may be point where the distance between the first circuit pattern and the pad is minimum.

Further, the dam may have a semicircular shape.

Further, one side of the dam may be in contact with the first circuit pattern, an arc portion may face the pad, and one vertex of the side in contact with the first circuit pattern may consist of at least two semicircles positioned in the second weak portion.

In accordance with another aspect of the present invention to achieve the object, there is provided a method of preventing a circuit width thinning defect for preventing a circuit width thinning defect of a weak portion by using first design information and second design information which are data related to a design for forming a circuit pattern, including: a weak portion analysis step of analyzing the first design information to deduce the type of the weak portion and the position of the weak portion; a dam matching step of extracting dam design information corresponding to the type of the weak portion deduced in the weak portion analysis step; and a design information change step of changing the first design information to add the dam design information extracted in the dam matching step to the position of the weak portion deduced in the weak portion analysis step.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view for explaining the difference in etching amount according to the flow rate of an etching solution;

FIGS. 2(a) and 2(b) are views showing weak portions in which a circuit width thinning defect occurs;

FIG. 3 is a view schematically showing a circuit width thinning defect prevention device in accordance with an embodiment of the present invention;

FIG. 4 is a view schematically showing a method of preventing a circuit width thinning defect in accordance with an embodiment of the present invention;

FIGS. 5(a) to 5(c) are views for explaining the case in which a circuit width thinning defect occurs and a weak portion;

FIGS. 6(a) and 6(b) are views schematically showing the shape in which a dam for preventing a circuit width thinning defect in accordance with an embodiment of the present invention is provided; and

FIGS. 7(a) to 7(c) are view schematically showing the shape in which the weak portion and the matched dam are provided in each case in which the circuit width thinning defect occurs.

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Hereinafter, configurations and operational effects of the present invention will be described in detail with reference to the accompanying drawings.

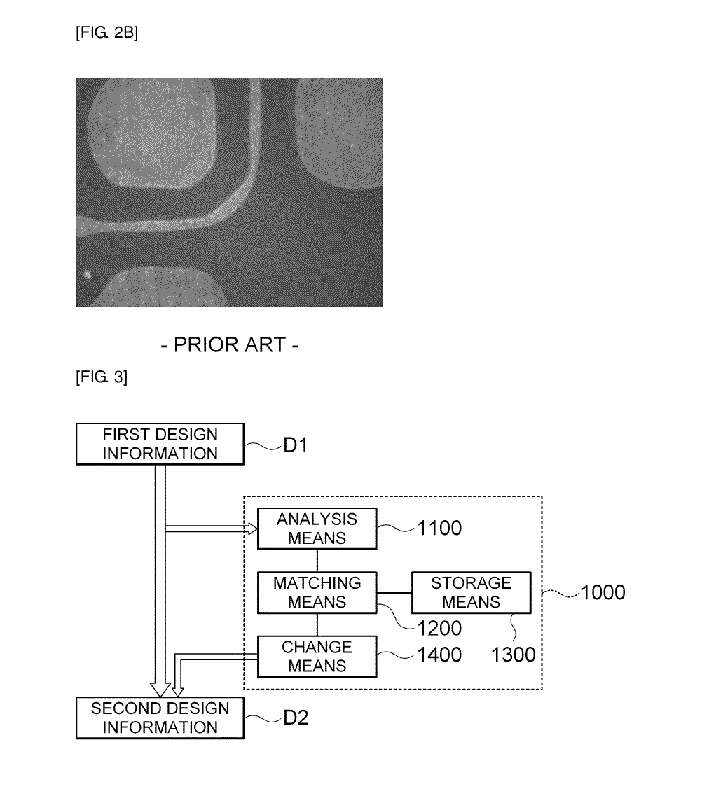

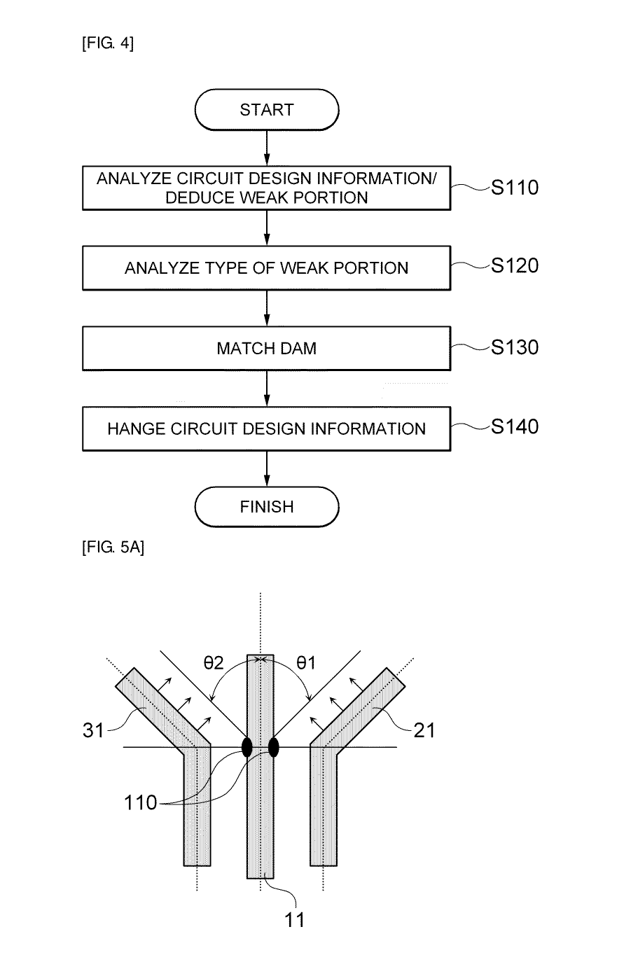

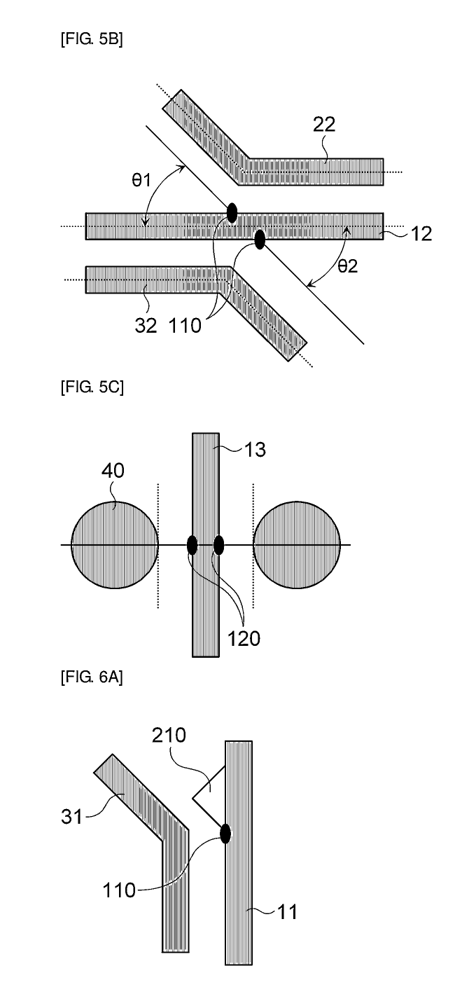

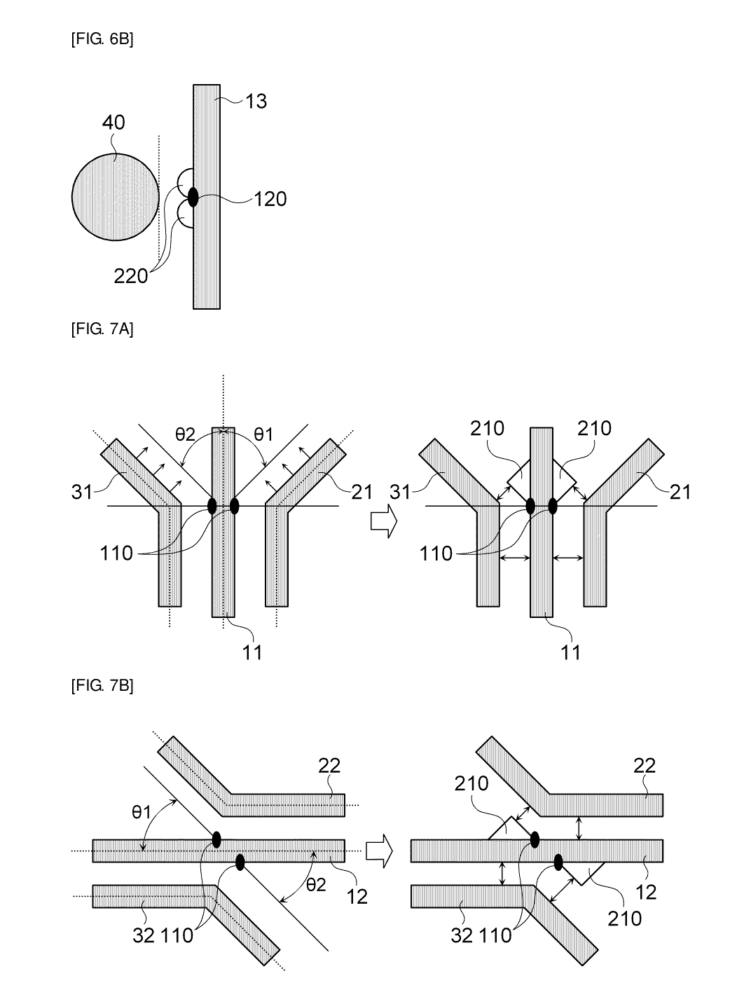

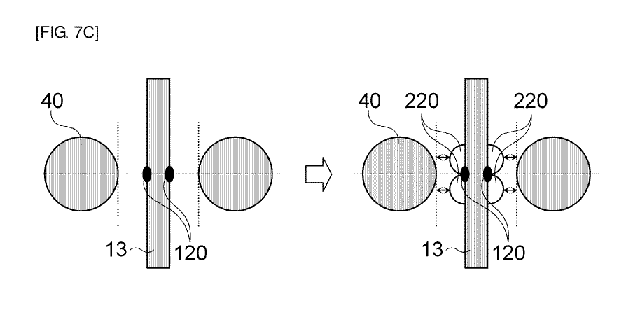

FIG. 3 is a view schematically showing a circuit width thinning defect prevention device 1000 in accordance with an embodiment of the present invention, FIG. 4 is a view schematically showing a method of preventing a circuit width thinning defect in accordance with an embodiment of the present invention, FIGS. 5(a) to 5(c) are views for explaining the case in which a circuit width thinning defect occurs and a weak portion, FIGS. 6(a) and 6(b) are views schematically showing the shape in which a dam for preventing a circuit width thinning defect in accordance with an embodiment of the present invention is provided, and FIGS. 7(a) to 7(c) are views schematically showing the shape in which the weak portion and the matched dam are provided in each case in which the circuit width thinning defect occurs.

Referring to FIGS. 3 to 7(c), a circuit width thinning defect prevention device 1000 in accordance with an embodiment of the present invention may include an analysis means 1100, a matching means 1200, a change means 1400, and a storage means 1300 and prevent a circuit width thinning defect of a weak portion by changing first design information D1 into second design information D2.

A representative method of the methods widely used in printed circuit board (PCB) manufacturing fields is a tenting method of forming a resist pattern by irradiating light to a conductive layer applied with a photosensitive material using a photo plotter and forming a circuit pattern by etching the conductive layer.

At this time, digitalized data are provided so that the photo plotter can form the resist pattern. As these data, Gerber format data are currently the most widely used.

The Gerber format data consist of elements such as file parameters, X/Y coordinate data, and function commands and include design information of a circuit pattern that is formed finally.

In the present specification, the design information of the circuit pattern will be referred to as the first design information D1 and the second design information D2.

That is, the first design information D1 and the second design information D2, which are Gerber format data, may be information provided to a photo plotter etc. to form a circuit pattern.

Meanwhile, the first design information D1 is basic data made for forming a circuit pattern and changed to complement the weak portion by the circuit width thinning defect prevention device 1000 in accordance with an embodiment of the present invention.

That is, the data obtained by changing the first design information D1 by the circuit width thinning defect prevention device 1000 in accordance with an embodiment of the present invention may be referred to as the second design information D2.

The analysis means 1100 may deduce the type and position of the weak portion by analyzing the first design information D1.

Referring to FIGS. 5(a) and 5(b), it will be understood that a second circuit pattern 21 and 22 and a third circuit pattern 31 and 32 are disposed adjacent to a first circuit pattern 11 and 12.

First, as shown in FIG. 5(a), the first circuit pattern 11, the second circuit pattern 21, and the third circuit pattern 31 are parallel to each other, but the interval therebetween increases upward.

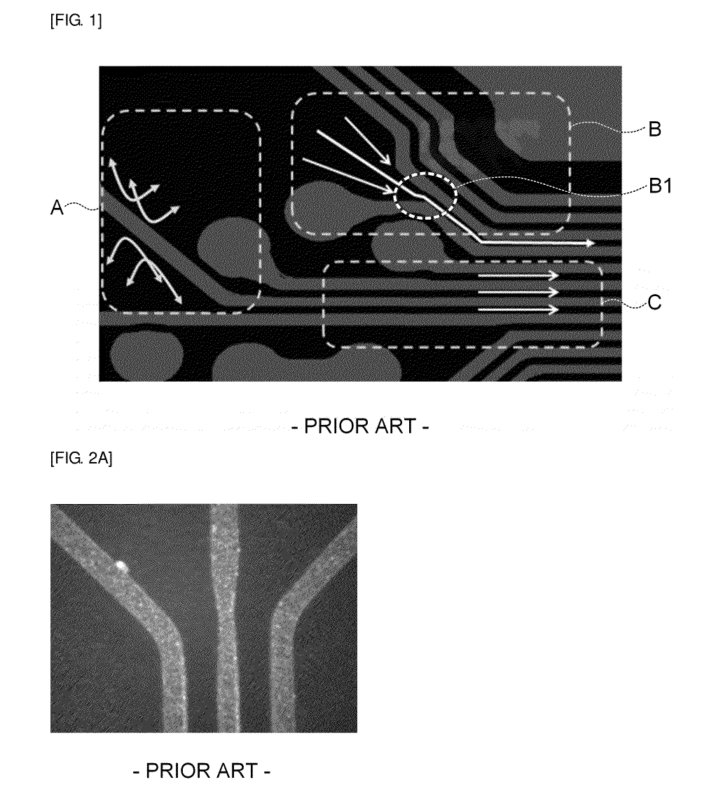

As described above with reference to FIGS. 1 and 2, as the flow rate of an etching solution rapidly increases in a point where the first circuit pattern 11 and the second circuit pattern 21 start getting away from each other and in a point where the first circuit pattern 11 and the third circuit pattern 31 start getting away from each other, excessive etching may occur, thus causing thinning of a circuit width that is a so-called circuit width thinning defect.

Therefore, the point where the first circuit pattern 11 and the second circuit pattern 21 start getting away from each other and the point where the first circuit pattern 11 and the third circuit pattern 31 start getting away from each other may be defined as a first weak portion 110.

In the drawings, an acute angle between the first circuit pattern 11 and a virtual line parallel to the second circuit pattern 21 while passing through the point where the first circuit pattern 11 and the second circuit pattern 21 start getting away from each other is indicated by θ1.

Further, an acute angle between the first circuit pattern 11 and a virtual line parallel to the second circuit pattern 21 while passing through the point where the first circuit pattern 11 and the third circuit pattern 31 start getting away from each other is indicated by θ2.

That is, the first weak portion 110 may mean the point where the angle θ1 between the virtual line positioned on the first circuit pattern 11 in parallel to the second circuit pattern 21 and the first circuit pattern 11 is changed by more than 1 degree or the point where the angle θ2 between the virtual line positioned on the first circuit pattern 11 in parallel to the third circuit pattern 31 and the first circuit pattern 11 is changed by more than 1 degree.

Meanwhile, referring to FIG. 5(b), it will be understood that the directions in which the second circuit pattern 22 and the third circuit pattern 32 get away from the first circuit pattern 12 are opposite to each other.

Further, referring to FIG. 5(c), a pad 40 may be adjacent to the first circuit pattern 13.

At this time, as described above with reference to FIGS. 1 and 2, when the first circuit pattern 13 and the pad 40 are adjacent to each other, as the flow rate of the etching solution rapidly increases in the point positioned on the first circuit pattern 13 among the points where the distance between the first circuit pattern 13 and the pad 40 is minimum, excessive etching may occur, thus causing thinning of a circuit width that is a so-called circuit width thinning defect.

Therefore, the point positioned on the first circuit pattern 13 among the points where the distance between the first circuit pattern 13 and the pad 40 is minimum may be defined as a second weak portion 120.

Accordingly, the analysis means 1100 may perform a function of deducing the above-described first weak portion 110 and second weak portion 120 by analyzing the first design information D1. At this time, it is possible to deduce the positions of the first weak portion 110 and the second weak portion 120 by distinguishing the types of the first weak portion 110 and the second weak portion 120.

That is, the analysis means 1100 can grasp the design of the circuit patterns by analyzing the first design information D1 such as Gerber format data and find the points corresponding to the first weak portion 110 and the second weak portion 120 in the design of the circuit patterns using a digital logic.

Referring to FIG. 6(a), it is shown that a first dam 210 is provided between the first circuit pattern 11 and the third circuit pattern 31.

As shown, the first dam 210 may be formed in the shape of a triangle whose one side is in contact with the first circuit pattern 11.

At this time, one vertex of the side in contact with the first circuit pattern 11 may be positioned in the first weak portion 110, and the other vertex may be positioned in the direction in which the interval between the first circuit pattern 11 and the third circuit pattern 31 increases.

Accordingly, the first dam 210 mitigates the flow of the etching solution in the direction in which the interval between the first circuit pattern 11 and the third circuit pattern 31 is wide and then becomes narrow and prevents the excessive etching of the first weak portion 110 by preventing the etching solution from rapidly flowing in the weak portion 110.

Meanwhile, at least one of the sides of the first dam 210, which are not in contact with the first circuit pattern 11, is parallel to the third circuit pattern 31 to efficiently prevent the rapid acceleration of the etching solution in the first weak portion 110.

Referring to FIG. 6(b), it is shown that a second dam 220 is provided between the first circuit pattern 13 and the pad 40.

As shown, the second dam 220 may have a semicircular shape, and one side thereof may be in contact with the first circuit pattern 13.

At this time, an arc portion of the second dam 220 may be positioned toward the pad 40, and one vertex of the side in contact with the first circuit pattern 13 may be positioned in the second weak portion 120.

Further, the second dam 220 may consist of two semicircles which are positioned on both sides based on the second weak portion 120.

Here, the second dam 220 may be a portion of an oval.

Accordingly, the second dam 220 mitigates the flow of the etching solution in the direction in which the interval between the first circuit pattern 13 and the pad 40 is wide and then becomes narrow and prevents the excessive etching of the second weak portion 120 by preventing the etching solution from rapidly flowing in the second weak portion 120.

Like this, dam design information for designing the first dam 210 corresponding to the first weak portion 110 and the second dam 220 corresponding to the second weak portion 120 may be stored in the storage means 1300.

At this time, the dam design information may be changed according to the interval and angle between the patterns constituting the first weak portion 110 as well as the classification according to the first weak portion 110 and the second weak portion 120.

For example, the size or internal angle of the triangular first dam 210 may be changed according to the distance between the first circuit pattern 11 and 12 and the second circuit pattern 21 and 22 or the size of the acute angle θ2 between the virtual line parallel to the third circuit pattern 31 and 32 while passing through the point where the first circuit pattern 11 and 12 and the third circuit pattern 31 and 32 start getting away from each other and the first circuit pattern 11 and 12. Therefore, the optimized design information of the first dam 210 and the second dam 220 may be arranged into a lookup table etc. to be stored in the storage means 1300.

These points may be equally applied to the second weak portion 120.

Accordingly, the optimized dam design information may be extracted from the storage means 1300 according to whether the type of the weak portion deduced from the analysis of the first design information D1 by the analysis means 1100 is the first weak portion 110 or the second weak portion 120, and this extraction process may be performed by the matching means 1200.

That is, the matching means 1200 extracts the optimized dam design information by using the type of the weak portion deduced by the analysis means 1100, the distance between the first circuit pattern 11 and 12 and the second circuit pattern 21 and 22, and the size of the acute angle θ2 between the virtual line parallel to the third circuit pattern 31 and 32 while passing through the point where the first circuit pattern 11 and 12 and the third circuit pattern 31 and 32 start getting away from each other and the first circuit pattern 11.

Next, the change means 1400 reflects the dam design information extracted by the matching means 1200 to the first design information D1 so that the dams 210 and 220 can be provided in the weak portions 110 and 120.

That is, the change means 140 generates the second design information D2 by changing the first design information D1 so that the dam can be added to the weak portion in the circuit pattern design according to the first design information D1.

Accordingly, when actually forming a resist pattern using a photo plotter etc., if the resist pattern is formed according to the second design information D2, the resist pattern in which the dam is added to the weak portion can be formed, and it is possible to prevent a circuit width thinning defect by performing etching using the resist pattern.

FIGS. 7(a) to 7(c) are view schematically showing the shape in which the weak portion and the matched dam are provided in each case in which the circuit width thinning defect occurs. Referring to what is shown in FIGS. 7(a) to 7(c), it will be understood that the excessive etching of the first weak portion 110 is prevented by the first dam 210 and the excessive etching of the second weak portion 120 is prevented by the second dam 220.

FIG. 4 is a view schematically showing a method of preventing a circuit width thinning defect in accordance with an embodiment of the present invention.

Referring to FIG. 4, a method of preventing a circuit width thinning defect in accordance with an embodiment of the present invention may include a weak portion analysis step, a dam matching step, and a design information change step.

First, in the weak portion analysis step, circuit design information is analyzed to deduce a weak portion (S110, S120).

That is, the above-described first design information D1 is analyzed to deduce the type and position of a first weak portion 110 or a second weak portion 120, and the weak portion analysis step may be performed by the above-described analysis means 1100.

Next, in the dam matching step, dam design information optimized to mitigate a sudden change in the flow rate of an etching solution according to the type of the weak portion deduced in the previous step is extracted (S130).

At this time, the dam design information may be stored in the above-described storage means 1300, and the dam matching step may be performed by the above-described matching means 1200.

Next, in the design information change step, the initial circuit design information, that is, the first design information D1 is changed (S140).

Specifically describing, the first design information D1 is changed so that dams 210 and 220 according to the dam design information extracted in the dam matching step can be reflected to the first weak portion 110 and the second weak portion 120.

This design information change step may be performed by the above-described change means 1400, and second design information D2, which is new design information obtained by changing the first design information D1, can be generated.

Accordingly, when actually forming a resist pattern using a photo plotter etc., if the resist pattern is formed according to the second design information D2, the resist pattern in which the dam is added to the weak portion can be formed, and it is possible to prevent a circuit width thinning defect by performing etching using the resist pattern.

The present invention configured as above can prevent a circuit width thinning defect, that is, a reduction in circuit width due to excessive etching on a specific portion. Accordingly, it is possible to implement a fine circuit pattern, which can't be implemented by a conventional tenting method, by a tenting method.

1. A circuit width thinning defect prevention device for preventing a circuit width thinning defect of a weak portion by using first design information and second design information which are data related to a design for forming a circuit pattern, comprising:
a storage means for storing dam design information classified according to the type of the weak portion;
an analysis means for analyzing the first design information to deduce the type of the weak portion and the position of the weak portion;
a matching means for extracting the dam design information corresponding to the type of the weak portion deduced by the analysis means from the dam design information stored in the storage means; and
a change means for changing the first design information to add a dam according to the dam design information extracted by the matching means to the position of the weak portion deduced by the analysis means.

2. The circuit width thinning defect prevention device according to claim 1, wherein the weak portion is a first weak portion positioned on a first circuit pattern between the first circuit pattern and a second circuit pattern adjacent to the first circuit pattern.

3. The circuit width thinning defect prevention device according to claim 2, wherein the first weak portion is a point where the distance between the first circuit pattern and the second circuit pattern is changed.

4. The circuit width thinning defect prevention device according to claim 3, wherein the first weak portion is a point where the angle between a virtual line positioned on the first circuit pattern in parallel to the second circuit pattern and the first circuit pattern is changed by more than 1 degree.

5. The circuit width thinning defect prevention device according to claim 2, wherein the dam has a triangular shape.

6. The circuit width thinning defect prevention device according to claim 5, wherein one side of the dam is in contact with the first circuit pattern, one vertex of the side in contact with the first circuit pattern is positioned in the first weak portion, and the other vertex is positioned in the direction in which the interval between the first circuit pattern and the second circuit pattern increases.

7. The circuit width thinning defect prevention device according to claim 6, wherein at least one of the sides of the dam, which are not in contact with the first circuit pattern, is parallel to the second circuit pattern.

8. The circuit width thinning defect prevention device according to claim 1, wherein the weak portion is a second weak portion positioned on the first circuit pattern between the first circuit pattern and a pad adjacent to the first circuit pattern.

9. The circuit width thinning defect prevention device according to claim 8, wherein the second weak portion is point where the distance between the first circuit pattern and the pad is minimum.

10. The circuit width thinning defect prevention device according to claim 9, wherein the dam has a semicircular shape.

11. The circuit width thinning defect prevention device according to claim 10, wherein one side of the dam is in contact with the first circuit pattern, an arc portion faces the pad, and one vertex of the side in contact with the first circuit pattern consists of at least two semicircles positioned in the second weak portion.

12. A method of preventing a circuit width thinning defect for preventing a circuit width thinning defect of a weak portion by using first design information and second design information which are data related to a design for forming a circuit pattern, comprising:
a weak portion analysis step of analyzing the first design information to deduce the type of the weak portion and the position of the weak portion;
a dam matching step of extracting dam design information corresponding to the type of the weak portion deduced in the weak portion analysis step; and
a design information change step of changing the first design information to add the dam design information extracted in the dam matching step to the position of the weak portion deduced in the weak portion analysis step.

13. A method of preventing a circuit width thinning defect for preventing a circuit width thinning defect of a weak portion by using a circuit width thinning defect prevention device according to claim 1, comprising:
a weak portion analysis step of analyzing the first design information to deduce the type of the weak portion and the position of the weak portion;
a dam matching step of extracting dam design information corresponding to the type of the weak portion deduced in the weak portion analysis step; and
a design information change step of changing the first design information to add the dam design information extracted in the dam matching step to the position of the weak portion deduced in the weak portion analysis step.

14. A method of preventing a circuit width thinning defect for preventing a circuit width thinning defect of a weak portion by using a circuit width thinning defect prevention device according to claim 2, comprising:
a weak portion analysis step of analyzing the first design information to deduce the type of the weak portion and the position of the weak portion;
a dam matching step of extracting dam design information corresponding to the type of the weak portion deduced in the weak portion analysis step; and
a design information change step of changing the first design information to add the dam design information extracted in the dam matching step to the position of the weak portion deduced in the weak portion analysis step.

15. A method of preventing a circuit width thinning defect for preventing a circuit width thinning defect of a weak portion by using a circuit width thinning defect prevention device according to claim 3, comprising:
a weak portion analysis step of analyzing the first design information to deduce the type of the weak portion and the position of the weak portion;
a dam matching step of extracting dam design information corresponding to the type of the weak portion deduced in the weak portion analysis step; and
a design information change step of changing the first design information to add the dam design information extracted in the dam matching step to the position of the weak portion deduced in the weak portion analysis step.

16. A method of preventing a circuit width thinning defect for preventing a circuit width thinning defect of a weak portion by using a circuit width thinning defect prevention device according to claim 4, comprising:
a weak portion analysis step of analyzing the first design information to deduce the type of the weak portion and the position of the weak portion;
a dam matching step of extracting dam design information corresponding to the type of the weak portion deduced in the weak portion analysis step; and
a design information change step of changing the first design information to add the dam design information extracted in the dam matching step to the position of the weak portion deduced in the weak portion analysis step.

17. A method of preventing a circuit width thinning defect for preventing a circuit width thinning defect of a weak portion by using a circuit width thinning defect prevention device according to claim 5, comprising:
a weak portion analysis step of analyzing the first design information to deduce the type of the weak portion and the position of the weak portion;
a dam matching step of extracting dam design information corresponding to the type of the weak portion deduced in the weak portion analysis step; and
a design information change step of changing the first design information to add the dam design information extracted in the dam matching step to the position of the weak portion deduced in the weak portion analysis step.

18. A method of preventing a circuit width thinning defect for preventing a circuit width thinning defect of a weak portion by using a circuit width thinning defect prevention device according to claim 6, comprising:
a weak portion analysis step of analyzing the first design information to deduce the type of the weak portion and the position of the weak portion;
a dam matching step of extracting dam design information corresponding to the type of the weak portion deduced in the weak portion analysis step; and
a design information change step of changing the first design information to add the dam design information extracted in the dam matching step to the position of the weak portion deduced in the weak portion analysis step.

19. A method of preventing a circuit width thinning defect for preventing a circuit width thinning defect of a weak portion by using a circuit width thinning defect prevention device according to claim 7, comprising:
a weak portion analysis step of analyzing the first design information to deduce the type of the weak portion and the position of the weak portion;
a dam matching step of extracting dam design information corresponding to the type of the weak portion deduced in the weak portion analysis step; and
a design information change step of changing the first design information to add the dam design information extracted in the dam matching step to the position of the weak portion deduced in the weak portion analysis step.

20. A method of preventing a circuit width thinning defect for preventing a circuit width thinning defect of a weak portion by using a circuit width thinning defect prevention device according to claim 8, comprising:
a weak portion analysis step of analyzing the first design information to deduce the type of the weak portion and the position of the weak portion;
a dam matching step of extracting dam design information corresponding to the type of the weak portion deduced in the weak portion analysis step; and
a design information change step of changing the first design information to add the dam design information extracted in the dam matching step to the position of the weak portion deduced in the weak portion analysis step.
